(19) United States
(12) Patent Application Publication
(10) Pub. No.: US 2012/0039177 A1
(43) Pub. Date: Feb. 16, 2012

(54) Method for Monitoring Network Nodes

(75) Inventors: Martin Kubisch, Berlin (DE); Matthias Kühm, Waltershausen (DE); Andreas Willig, Berlin (DE); Adam Wolisz, Berlin (DE)

(73) Assignee: Siemens Aktiengesellschaft, Munchen (DE)

(21) Appl. No.: 13/140,792

(22) PCT Filed: Nov. 10, 2009
(86) PCT No.: PCT/EP09/64864

§ 371 Date: Oct. 12, 2011

(30) Foreign Application Priority Data
Dec. 17, 2008 (DE) 10 2008 063 454.9

(51) Int. Cl. H04W 24/02

(52) U.S. Cl. 370/241

(57) ABSTRACT

A method for mutual monitoring of mobile network nodes of a network, wherein each network node continuously monitors the presence of neighboring network nodes of a certain group of network nodes, the particular network node checks whether it receives beacon data packets, which are sent from the neighboring network nodes at regular time intervals, from the neighboring network nodes over an interface. The relative proximity of the network nodes to each other is monitored without requiring a network infrastructure. The network comprising mobile network nodes is suitable for all applications in which spatial proximity between related members of a group is to be monitored, wherein the group members may be persons, animals or objects.

### BACKGROUND OF THE INVENTION

1. Field of the Invention

The invention relates to mobile communication networks and, more particularly, to a method for continuously monitoring a presence of mobile network nodes of a wireless sensor network.

2. Description of the Related Art

As a rule, mobile network nodes contain transceivers for wireless data transmission. Systems are known that ascertain, by using wireless data transmission, the position of mobile network nodes that are attached to any desired entities, such as people, domestic animals or objects. For example, visitors are fitted with armbands or pendants in some amusement and leisure parks, which contain a Radio Frequency Identification (RFID) chip or a WiFi node. Furthermore, domestic animals, such as sheep or cows, are fitted with neck bands, which have a GPS receiver and, where required, further communications systems.

However, these conventional systems for monitoring the presence of entities require the, availability of a wireless infrastructure, such as an RFID reader or a WiFi access point. Due to the need for an available infrastructure, conventional systems of this type are therefore restricted to a defined, predetermined geographical area.

Furthermore, conventional systems of this type merely monitor the presence of one entity, such as one object, one person or one domestic animal, within the predetermined geographical area but not the proximity of the group members of a group of entities to each other. Only if an entity is located outside the monitored geographical area, such as outside a visitor park, is the loss of the respective group member reported. In many applications, however, it is a requirement to ascertain the relative proximity of entities to each other. However, there is no infrastructure in many cases and many environments with the aid of which the presence and relative positions of different entities with respect to each other can be determined. For example, a class teacher on an excursion, such as a walk in the countryside, has no possibility at all of ascertaining whether a student has become lost from the group.

### SUMMARY OF THE INVENTION

It is therefore an object of the present invention to provide a method and a system for continuously monitoring the presence of network nodes, which does not need any available infrastructure in the respective area.

This and other objects and advantages are achieved in accordance with the invention by providing mobile network nodes, where a respective network node continuously monitors the presence of network nodes in a specific group of network nodes, and the network node checks whether it is receiving, over an interface, beacon data packets from the specific group of network nodes, where the data packets are sent out at regular time intervals by the specific group of network nodes.

These mobile network nodes can be attached to any desired entities or worn by the entities respectively. For example, people, domestic animals or objects can be fitted with mobile network nodes in accordance with the invention.

In an embodiment of the inventive mobile network node, a beacon data packet received by the mobile network node includes an identifier for that network node from which the beacon data packet is sent out.

Consequently, it is possible for the receiving network node to identify another network node from which it has received a beacon data packet and can, therefore, ascertain that the node has not become lost from the group or moved away too far, respectively.

In an embodiment of the inventive mobile network node, the mobile network node includes a memory in which a monitoring list is stored. The list includes identifiers for all network nodes to be monitored by a respective network node.

It is possible to define, with the aid of this monitoring list, which other nodes are to be monitored by the respective network node. It is therefore possible to configure a group of mutually monitoring network nodes.

In an embodiment of the inventive mobile network node, the network node includes a microprocessor having at least one timer that checks whether the network node has received, within a predetermined time period, one associated beacon data packet in each case from all network nodes that it is to monitor.

By setting the timer, it is possible to define a response time of the network node at which the network node responds to the absence of another network node to be monitored.

In an embodiment of the inventive mobile network node, each beacon data packet received by the mobile network node includes not only the identifier of the network node that transmitted the beacon data packet, but also identifiers of those network nodes whose presence the transmitting network node is monitoring.

As a result, it is possible to ascertain whether a network node is being monitored sufficiently.

In an embodiment of the inventive mobile network node, the beacon data packet received by the mobile network node includes a numerical value that indicates how many network nodes are monitoring the presence of the network node that is sending the respective beacon data packet.

In this embodiment, it is possible to ascertain whether the sending network node is being monitored by enough other network nodes. Accordingly, the likelihood of an unnoticed loss of a group member or network node respectively is lowered.

In an embodiment of the inventive mobile network node, a loss list is stored in the memory of the network node of those identifiers of those network nodes to be monitored from which the network node does not receive an associated beacon data packet within a predetermined time period.

As a result, the possible loss of a group member or a network node can be rapidly detected.

In an embodiment of the inventive mobile network node, the network node enters in to the loss list of its memory an identifier of a disappeared network node to be monitored, from which the network node has not received an associated beacon data packet within the predetermined time period, and broadcasts over its radio interface, as a broadcast message, a search request to search for the disappeared network node.

In the case of this embodiment, it is ensured that any network node that is possibly lost is rapidly searched for within the network node.

In an embodiment of the inventive mobile network node, the search request has a decrementable adaptively settable hop value that indicates whether a network node that receives the search request broadcasts its decrementable adaptively settable hop value as a broadcast message.

As a result, it is possible to set the number of further nodes, or the environment respectively, in which the possibly lost network node is searched for within the network.

In a further embodiment of the inventive mobile network node, the network node generates a message if it receives a search request to search for a disappeared network node, and ascertains that the identifier of the disappeared network node is in its monitoring list but not in its loss list.

In an embodiment of the inventive mobile network node, the received beacon data packet includes sensor data of a sensor of a respective transmitting network node, operating state data of the respective transmitting network node, and an identifier of a network that indicates to which network the network node belongs.

In an embodiment of the inventive mobile network node, the beacon data packet received by the network node is transmitted in encrypted form with the aid of a key that is available to all network nodes in the network.

The presently contemplated embodiment offers the advantage that reports or messages respectively, which are exchanged between the network nodes, cannot be listened in to and analyzed by unauthorized third parties. Moreover, it is possible, by issuing keys, to configure or define respective group members or network nodes of respective different networks.

In a possible embodiment of the inventive mobile network node, the stored loss list of the network node can be read out by a central network node. Alternatively, a user can interrogate the stored loss lists of one or more network nodes by using an external terminal, i.e., a network node not belonging to the network, such as by using a PDA or laptop.

As a result, it is possible to ascertain centrally all group members or network nodes respectively that are lost or absent within the network.

It is also an object of the invention to provide a mesh network with a plurality of mobile network nodes, where each network node continuously monitors the presence of other network nodes in a specific group of network nodes, the respective network node checks whether it is receiving, over an interface, and in particular a radio interface, beacon data packets from the said network nodes, and where the beacon data packets are sent out at regular time intervals by the network nodes.

It is also an object of the invention to provide a method for continuously monitoring the presence of other network nodes, where each network node of a network checks whether it is receiving, in a predefined time period, beacon data packets that are sent out at regular time intervals by the other network nodes in the network.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, embodiments of the inventive method for continuously monitoring the presence of network nodes, and in particular mobile network nodes, within a mesh network are described by reference to the enclosed figures, in which:

FIG. 1 is an exemplary schematic block diagram of a network consisting of a plurality of mobile network nodes in accordance with the invention;

FIG. 2 is a schematic block diagram of a mobile network node in accordance with an embodiment of the invention;

FIG. 3 A data structure diagram of a beacon data packet in a network consisting of mobile network nodes in accordance with an embodiment of the invention; and

FIGS. 4-14 are state diagrams of different processes running within a mobile network node in accordance with the invention, which enable continuous monitoring of the presence of other network nodes.

### DETAILED DESCRIPTION OF THE PREFERRED EMBODIMENTS

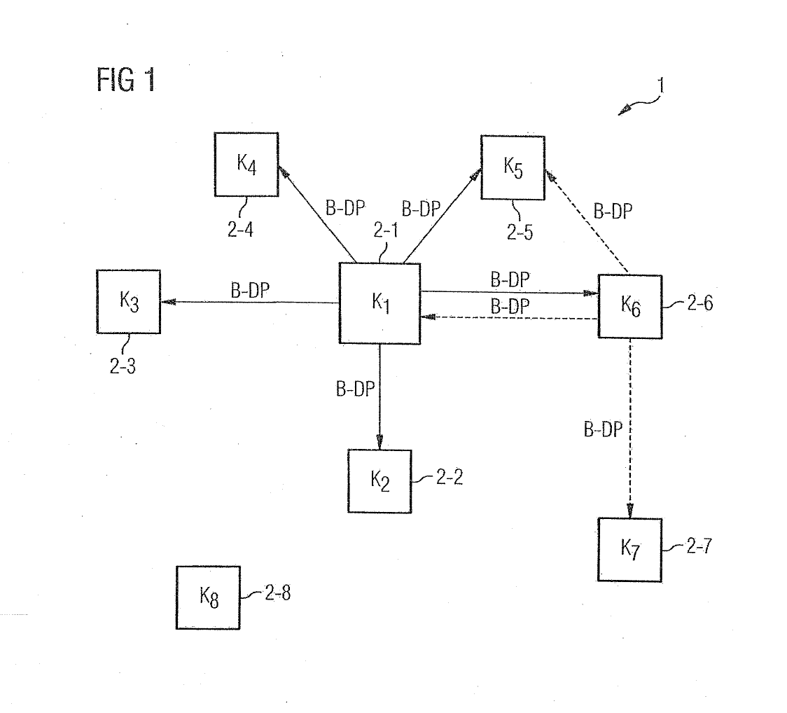

With specific reference to FIG. 1, a network 1, which can consist of a plurality of mobile network nodes 2, includes, for example, eight network nodes 2-1 to 2-8. Each node 2-i within the network 1 monitors the presence of neighboring network nodes, where each network node sends out “beacon data packets” at regular time intervals to report its presence to other network nodes. Moreover, each network node 2-i checks whether it is receiving, in a predefined time period, beacon data packets that are sent out at regular time intervals by other network nodes in the network 1. FIG. 1 indicates that the network node 2-1 is sending out beacon data packets to neighboring network nodes that are being received by the nodes inasmuch as they are located within the transmission range of the network node 2-1. In the example shown in FIG. 1, the nodes 2-2, 2-3, 2-4, 2-5, and 2-6 are located in the neighborhood of the node 2-1, i.e., within its transmission range, and receive the beacon data packet B-DP broadcast by the node 2-1. Similarly, the node 2-6 broadcasts beacon data packets B-DP to its neighboring nodes 2-1, 2-5, and 2-7. Here, , the node 2-7 is a neighboring node of the node 2-6 but not a neighboring node of the node 2-1 because the node 2-7 is located outside the transmission range of the node 2-1 but still within the transmission range of the node 2-6. Like the node 2-7, as an example, the node 2-8 shown in FIG. 1 lies at the periphery of the group of nodes or the network 1, respectively. If the node 2-8 moves away so that the two nodes 2-1 and 2-2 lying nearest to it find themselves outside its transmission range, no other network node in the network 1 receives a beacon data packet from this lost node 2-8 any more.

The mobile network nodes 2-i shown in FIG. 1 can be worn by or attached to any desired entities, such as people, domestic animals or objects. As a result, the network nodes 2-1 to 2-8 shown in FIG. 1 can be located in any desired area, which does not need to have any wireless infrastructure at all available. For example, the mobile network nodes 2 can be worn by students on a class excursion or a walking day. Many further applications are possible. For example, mobile network nodes 2 of the type shown in FIG. 1, can be worn by different members of a skiing party, such as on a tour, in order to ascertain whether a member of the group has become lost or has moved too far away from the group. In this application example, the inventive mobile network node 2 can, for example, be integrated in to another device, such as an avalanche search device. It is furthermore possible for the network nodes 2-i shown in FIG. 1 to be attached to domestic animals in a herd to ascertain any loss of animals. A further application example comprises a wireless sensor network 1 with mobile sensor nodes 2-i, which monitor the presence of the other sensor nodes with respect to each other.

In the case of the network 1, each entity, i.e., each member of a group to be monitored, is first fitted with a corresponding network node 2. In a formation phase, the network 1 constitutes an interlinked mesh network. Each node 2 is configured such that it monitors a number of neighboring nodes. In this respect, configuration is preferably effected such that each mobile network node 2 monitors a sufficient number of other mobile network nodes. In order to enable its own monitoring by other network nodes, each network node 2 sends, at regular time intervals, special data packets over an integrated interface, such as a radio interface, and specifically beacon data packets. These beacon data packets B-DP contain an identifier or a label respectively for that network node 2 that sent out the beacon data packet, and also where relevant other data originating from observation by the respective network node 2 of its environment. In a possible embodiment, it is ensured in the network formation phase that the respective network 1 is connected, i.e., following the formation phase the group of network nodes 2 is complete and no group member or network node 2 respectively has become lost as yet. Upon the completion of network formation, every node 2 monitors, in a normal operating mode, its selected neighboring nodes in that it checks whether it is regularly receiving beacon data packets from its neighboring nodes regularly or not. To this end, a beacon data packet B-DP received by the mobile network nodes 2 has at least one identifier for that network node from which the respective beacon data packet B-DP originates or from which it has been sent out, respectively.

If a network node 2 captures a new neighboring node 2′ or receives a beacon data packet B-DP with a previously unknown identifier of a node respectively, it can, in a possible embodiment, store this identifier in an internal list and where relevant likewise monitor this new neighboring node 2′ in that it regularly checks its presence.

If a network node 2-i is detected as missing by a neighboring node 2-j or if the neighboring node 2-j receives no further beacon data packet B-DP from the neighboring node 2-i for a lengthy period, the network node 2-j starts up, in a possible embodiment, a search for the possibly lost neighboring node 2-i in the respective network 1. In a possible embodiment, only a search in the immediate vicinity, restricted to a few hops between the nodes, is initially performed in a first phase in this respect, and only in a further phase, inasmuch as the first local search fails, is a network-wide search in the overall network instigated. If this network-wide search is also unsuccessful, a message is broadcast through the whole network 1 indicating which network node has disappeared. To this end, each network node 2 in the network 1 has a list of disappeared nodes or a loss list, respectively.

If a network node 2-i identified as having disappeared is rediscovered by another network node 2-j that has stored the identity of the disappeared node 2-i in its loss list, the discovering network node 2-j broadcasts this message regarding the return of the disappeared node 2-i through the whole network 1.

In a possible embodiment, a predefined node or a specific number of further nodes can be selected from the network 1, by which the loss lists or the lists of respectively disappeared network nodes are read out, respectively. As a result, the disappearance of one or more network nodes 2 from the configured group can be ascertained quickly and reliably.

Many different variants and application cases of the inventive network 1 consisting of mobile network nodes 2, and the inventive method for continuously monitoring the presence of neighboring network nodes, are possible.

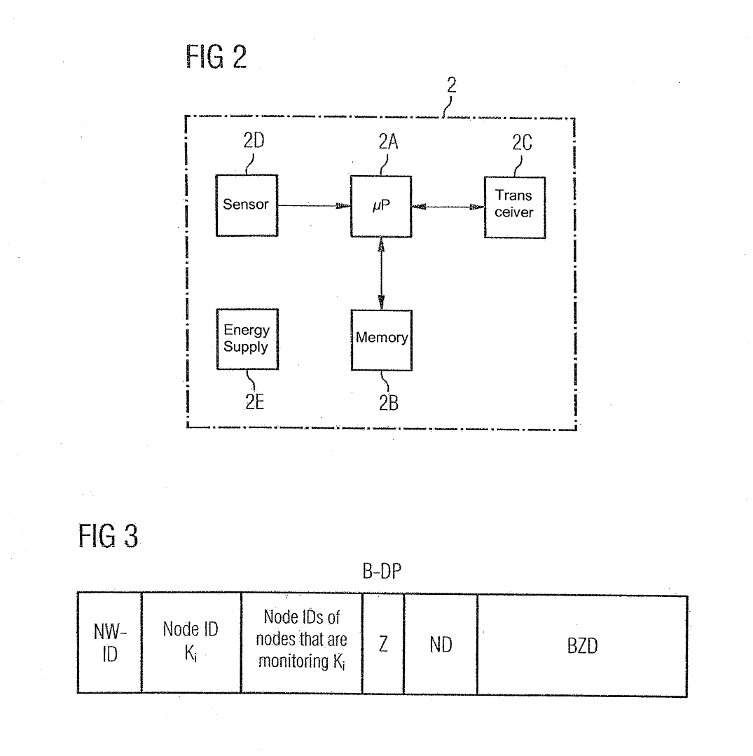

FIG. 2 shows a schematic block diagram of a network node 2 in accordance with an embodiment of the invention. The network node 2 has a microcontroller or a microprocessor 2A, respectively, which is connected to a data memory 2B. Furthermore, the network node 2 has a transceiver 2C, which is comprised of a wireless transmitter and receiver unit. Furthermore, in the exemplary embodiment shown in FIG. 2, the network node 2 optionally has a sensor 2D for capturing environmental conditions. Furthermore, it is possible for the network node 2 to have not only sensors but also actuators. The network node 2 has its own energy supply and supplies the internal circuits with power. For example, this energy supply unit 2E can be a battery or a solar cell.

As shown in FIG. 2, the microprocessor 2A can contain one or more configurable search timers. Various lists of node identifiers can be stored in the data memory 2B. The data memory 2B includes not only the actual node ID of the respective network node 2 but also, in a possible embodiment, a loss list, a monitoring list, and also a search list. The monitoring list includes the node IDs or identifiers respectively for the network nodes to be monitored by the network node 2. A loss list stores the respective identifiers or node IDs of those network nodes that are regarded as lost by the network node 2 shown in FIG. 2. The loss list stores those identifiers of those network nodes to be monitored from which the network node 2 has received no associated beacon data packet within a predetermined time period. The search list stores those network node IDs that belong to those nodes that are being searched for by the network node 2. The network node 2 enters an identifier of a disappeared network node to be monitored, from which it has received no associated beacon data packet B-DP within a predetermined time period, in its search list, and broadcasts a search request to search for the disappeared network node over an interface, such as a radio interface or the transceiver 2C, respectively, in the form of a broadcast message. The nodes in the search list represent candidates for the loss list, these nodes only being entered in the loss list when one or more search operations have been effected. If the search is successful, i.e., the searching node obtains a reply from another node to the effect that the node being searched for has been found, the searching node takes no further action since the node being searched for is still present in the network. Otherwise, the searching node enters the node being searched for in its loss list and floods the network with the information that the node being searched for has actually been lost. The other nodes accordingly also enter the lost node in their loss list.

FIG. 3 shows a data structure diagram of a beacon data packet B-DP, which is used by the inventive network 1 in accordance with an embodiment of the invention. The beacon data packet B-DP is transmitted by a network node 2-i at predefined regular time intervals ΔT and has at least the node ID of the transmitting node 2-i. In an embodiment of the inventive network 1, the time intervals ΔT at which a node 2-i transmits a beacon data packet B-DP according to FIG. 3 can be configured or set, respectively. In another embodiment, the time interval ΔT at which a beacon data packet B-DP is transmitted is also dependent on the operating state of the respective transmitting network node 2-i. If the energy supply of a sensor node as shown in FIG. 2 runs low, as an example, this sensor node 2-i can, in an embodiment, lower the rate or the transmission rate respectively at which beacon data packets are transmitted to save energy. As shown in FIG. 3, a beacon data packet B-DP of this type can also contain operating state data BZD of the respective transmitting node 2-i, which reflect the operating state of the transmitting node 2-i. For example, an energy supply state of the transmitting mobile network node 2-i can be indicated. If, in this embodiment, a network node 2-i reports in a beacon data packet B-DP, for example, that its energy supply will fail in the near future, such as because its battery is running low, the absence of further beacon data packets from this sensor node is not evaluated, in a possible embodiment, as the respective loss or moving away of the network node 2-i from the group but as a non-existent energy supply, where relevant a possible message being generated, such as the need to change the corresponding battery of the respective node 2-i.

As shown in FIG. 3, a beacon data packet B-DP within the inventive network 1 also has, in a possible embodiment, a network ID NW-ID, which identifies the respective network 1. As a result, it is possible to deploy different mobile network nodes 2 of different networks 1 in the same area without the possibility of confusion arising.

In an embodiment of the inventive network 1, each beacon data packet B-DP, as shown in FIG. 3, received by a mobile network node 2 not only has the identifier of the network node 2 that transmitted the respective beacon data packet B-DP but also the identifiers of those network nodes whose presence is being monitored by the respectively transmitting network node 2. Moreover, the beacon data packet, as shown in FIG. 3, can have a numerical value Z that indicates how many other network nodes are monitoring the presence of that network node 2 that is transmitting the beacon data packet B-DP. As a result, it is possible to ensure that for its part the transmitting network node 2 is being monitored by a sufficient number of other network nodes and therefore the loss of the network node 2 becomes more unlikely.

Moreover, a beacon data packet B-DP can also contain further user data ND, i.e., sensor data of sensors that are integrated in to the respective network node 2. The transmission of control data for actuators of a receiving network node is also possible. In an embodiment, the beacon data packet B-DP, as shown in FIG. 3, received by the network node 2 can be transmitted in encrypted form with the aid of a key that is known to the network nodes 1 of the network 1. As a result, any listening in to information by unauthorized third parties can be made more difficult.

In a preferred embodiment of the inventive network 1, the network nodes 2, as shown in FIG. 2, have a small form factor. A sensor network 1 in accordance with an exemplary embodiment of the present invention can consist of a large number of individual sensor nodes, where the nodes communicate with each other over a wireless communications interface. Due to the energy being supplied with the aid of a battery, a node 2 of this type only has a limited energy budget available as a rule. Accordingly, the lifetime of the respective network node 2 is limited. Consequently, in a preferred embodiment of the network node 2, the transceiver 2C is configured such that it has a relatively small transmission power of, for example, 1 mW or less. In this embodiment, a transmission range in the order of around 10 meters is achieved. In order to enable a greater geographical extension of the network, a multihop operating mode is provided in the inventive network 1. The network 1 according to the invention is preferably formed by a wireless mesh network. A network 1 of this type can have a lifetime of several months up to a few years. Here, the network 1 can encompass a plurality of nodes, such as 100-1,000 network nodes 2. Due to the inventive procedure of continuous monitoring of the presence of neighboring network nodes, the likelihood of the loss of a node 2 being noticed is virtually 100%. Moreover, the wireless transmission channel for transmitting respective the beacon data packets B-DP or the search requests can be a time-variable channel with varying transmission quality. The inventive method also takes into account the fact that respective data packets or beacon data packets can be lost due to poor transmission quality without this immediately resulting in a loss report of a network node 2. The inventive method therefore offers intelligent data processing of any observations undertaken, in particular of the beacon data packets received, in order to be able to ascertain the presence of all network nodes in a predefined group in a targeted manner. In a possible embodiment of the inventive network 1, the search for a possibly lost network node 2 is broadened step by step within the network 1, where, in a possible embodiment, a search request has a decrementable adaptively settable hop value that indicates whether a network node that receives a search request broadcasts this search request for its part as a broadcast message. A network node 2 that receives a search request of this type to search for a disappeared network node, and ascertains that the identifier of the disappeared network node 2 is in its monitoring list but not in its loss list can generate a corresponding report.

The method and network 1 in accordance with the invention permit a very high node density. Moreover, the network nodes can be located in any desired area that does not have any infrastructure at all. A further advantage of the inventive mobile network 1 consists in the fact that even in the case of network nodes 2 with restricted resources, and in particular with a limited energy supply, the lifetime is extended due to minimal energy consumption, the presence of the node 2 within the group nevertheless always being reliably monitored.

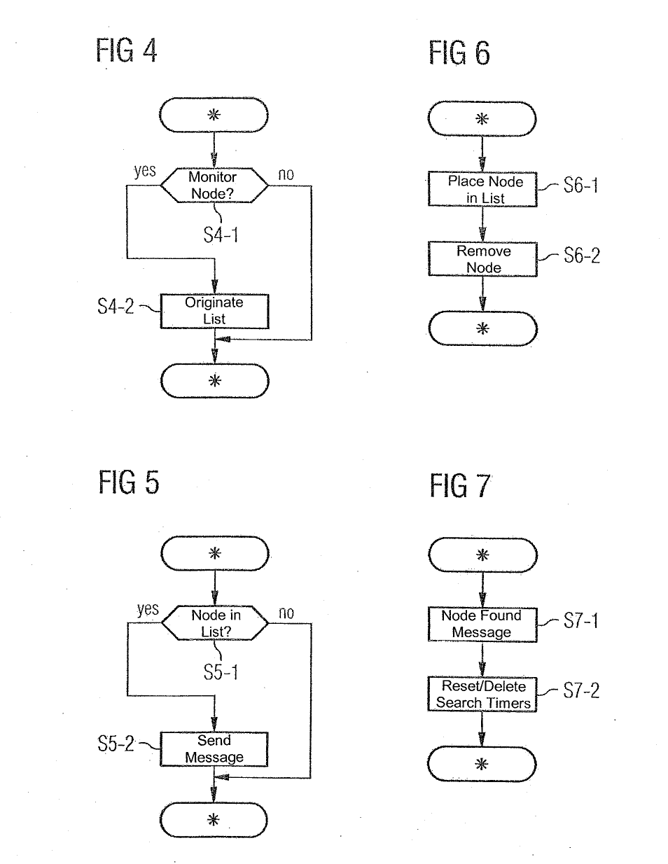

FIGS. 4-14 show state diagrams of processes running within a network node 2 for the purpose of performing the inventive method for continuously monitoring the presence of neighboring network nodes.

The transitions shown in FIGS. 4-14 show how the state of a network node 2 changes for a specific input event, such as the receipt of a beacon data packet or the expiration of a timer.

As shown in FIG. 4, a network node 2 is initially in a wait state (*) upon receipt of a beacon data packet. If the network node 2 receives a beacon data packet B-DP from a node k in the network and this node k is neither in the loss list, nor in the monitoring list, nor in the search list of the receiving network node 2, a check is carried out in S4-1 to determine whether the node k should be monitored. This can be decided based on different criteria. For example, it can be ascertained that the number of nodes that are monitoring the transmitting node k is not sufficient. To this end, the receiving node 2 compares the number of nodes monitoring the transmitting network node k indicated in the beacon data packet B-DP, for example, with a predefined threshold value. If, for example, the transmitting network node k whose beacon data packet B-DP is received is merely being monitored by two other network nodes and if the minimum number of monitoring nodes network-wide in accordance with a configuration is at least three monitoring network nodes per node, the receiving network node 2, as shown in FIG. 4, can place the node ID of the sending node k, whose monitoring is therefore not yet sufficient, on its monitoring list for further monitoring. If the memory space within the data memory 2B is not sufficient for this, then, in accordance with an embodiment, a node whose monitoring is sufficient can be removed from the monitoring list. Once the network node 2 has placed the node ID of the node k from which the beacon data packet B-DP originates on its monitoring list in step S4-2, it can return to the wait state.

FIG. 5 shows the receipt of a search request from another node by the network node 2 shown in FIG. 2. If the network node 2 receives a search request from another network node k, which for its part is searching for a node, the network node 2 checks in step S5-1 whether the node being searched for is in its monitoring list. If so, the network node 2 sends a message to the searching network node k in step S5-2 that the network node being searched for is present in its monitoring list and therefore has been found. Then the network node 2 returns to the wait state.

If the network node 2, as shown in FIG. 6, receives a beacon data packet B-DP from a node k and if this node k is in its search list, it places the node k on its monitoring list in step S6-1 and if necessary removes another node from the monitoring list. In a further step S6-2, the node k is removed from the search list of the receiving network node 2.

If the network node 2, as shown in FIG. 7, receives a message that a node k has been found in step S7-1, and if this node k is in the search list of the respective network node 2, the network node 2 removes the node k reported as found from its search list since the node k is being monitored by another network node. Moreover, in step S7-2, all search timers for the found node k are reset or deleted, respectively.

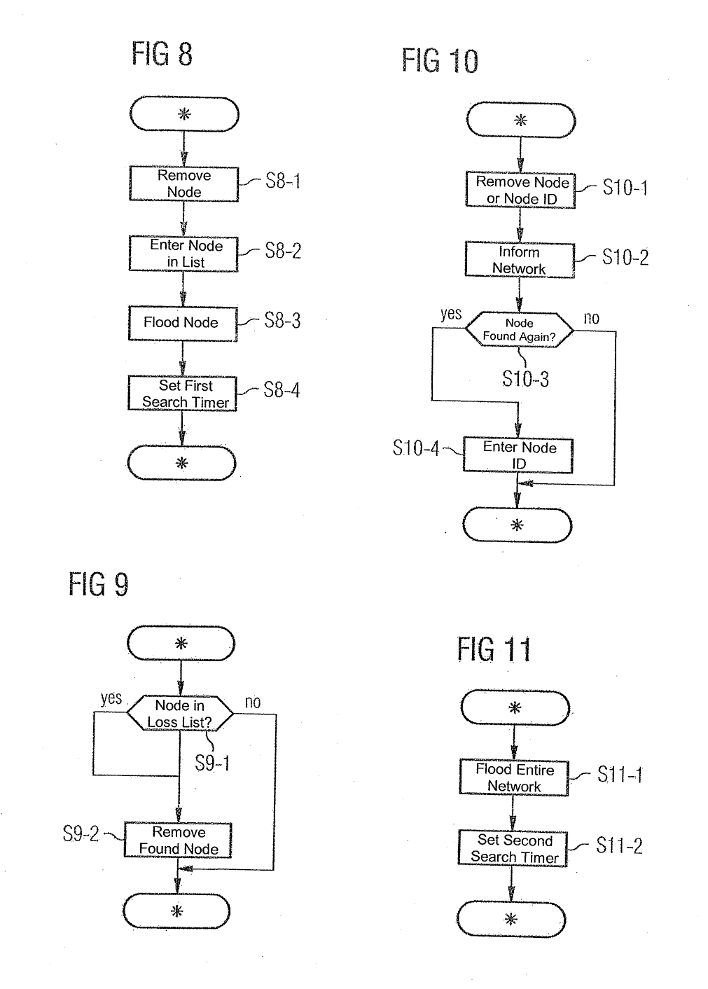

If, as shown in FIG. 8, a node k is classified or identified as lost, since the network node 2 has received no further beacon data packet B-DP from the monitored neighboring node k for a lengthy time period, for example, this monitored node k is initially removed from the monitoring list in step S8-1. Then this node k is entered in the search list of the network node 2 in step S8-2. In a further step S8-3, the local neighborhood within the network 1 is then flooded with a search request by the network node 2, the node ID of the node k being searched for being indicated in the search request. In an embodiment, the search request is restricted to neighboring nodes with a predefined hop distance within the network 1. Moreover, in step S8-4, a first search timer with a low time expiration duration t1 is set for the node k being searched for in the network node 2. Then the network node 2 returns to the wait state.

If the network node 2, as shown in FIG. 9, receives a message that a node k has been found again and if this node k, after a check in step S9-1, is in the loss list of the network node 2, the node ID of the found node k is removed from the loss list of the network node 2 in step S9-2.

If a network node 2, as shown in FIG. 10, receives a beacon data packet B-DP from a node k and if this node k is in the loss list of the network node 2, the node k or the node ID respectively is initially removed from the loss list of the network node 2 in step S10-1. Then, in step S10-2, the network node 2 informs the network 1 in a flood message that the node k has been found again.

In a further step S10-3, a decision is made based on a criterion as to whether the node k that has been found again should be monitored in future by the network node 2. If so, the node ID of the node k is entered in the monitoring list of the network node 2 in step S10-4.

If, as shown in FIG. 11, the search timer with the low time expiration duration t1 for a node k expires within the network node 2 and the network node 2 has therefore received no beacon data packet B-DP or no reply packet to its search packet within the time period t1 from the monitored node k, the monitoring network node 2, in an embodiment, floods the entire network 1 in step S11-1 with a search request regarding the possibly lost node k, the search request containing the node ID of the node k being searched for. In a further step S11-2, a second search timer is set for the node k being searched for with a higher time expiration duration t2. Then the network node 2 returns to the wait state.

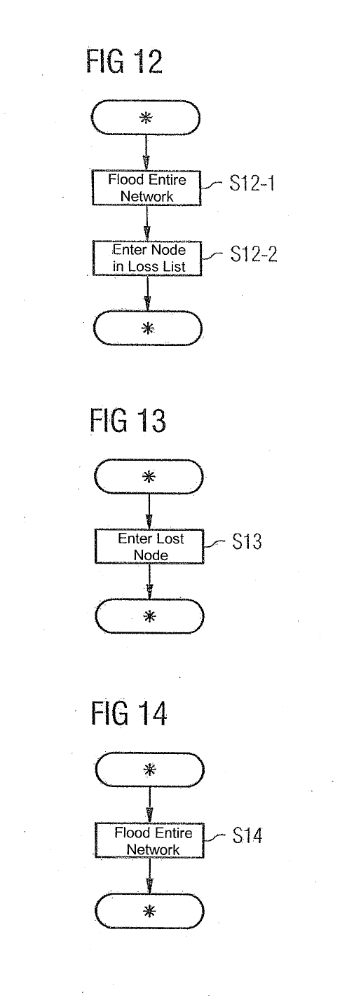

If, as shown in FIG. 12, the search timer with the higher time expiration duration t2 for the node k being searched for also expires within the network node 2, the monitoring network node 2 floods the entire network 1 in step S12-1 with a message reporting the loss of the node k. In a further step S12-2, the node k is entered in its loss list by the network node 2. Then the network node 2 returns to the wait state.

If the network node 2, as shown in FIG. 13, receives a report that a node k is lost and this node k is not yet in its loss list, the receiving network node 2 enters in its loss list, for its part, the lost node k designated in the loss report in step S13. Then the network node 2 returns to the wait state.

If, as shown in FIG. 14, a network node 2 receives a report that a node k is lost and this node k is in its monitoring list, the network node 2 floods the entire network 1 in step S14 with a message indicating that it has found the lost node k again. Then the network node 2 returns to the wait state.

In the exemplary embodiment represented in conjunction with FIGS. 4-14, the search for a lost node k is effected in two stages, i.e., in the first stage the search is effected, for example, in a local neighborhood of the nodes k, a few hops away. Only if this first search operation is unsuccessful is a search performed for the lost node k in the entire network 1. In a further embodiment of the inventive network 1, a finer gradation into a plurality of stages can be provided. For example, a search is initially performed only with immediately neighboring nodes k and then the search is extended in stages by one hop in each case.

The method in accordance with the invention can be deployed in many ways. Alongside the application cases already referred to, i.e., in the case of groups of visitors, school excursions or mountain tours, the respective system or network in accordance with the invention is suitable for monitoring objects in a logistical chain. For example, different individual parts of an overall object can each be provided with a network node 2 and can be transported from a first seaport to a second seaport in a shared transport container. As soon as an individual part is moved away from the other individual parts of the object, this loss can be reported. Another application example comprises the storage of individual or spare parts respectively within a store. The method and network in accordance with the invention are suitable for monitoring any desired objects against theft, such as objects that are located in a museum.

In an embodiment, a lost network node 2 can, for example, display which network or which node group it belongs to on a display, respectively.

In another embodiment, a network node 2 is located in a mobile device that, for example, includes a keyboard and a display. In a further embodiment, the loss lists of all mobile network nodes 2 contained in the mobile network 1 can be centrally interrogated or read out respectively with the aid of the mobile device. As a result, it is possible to ascertain which nodes are currently reported as lost.

In a further embodiment of the inventive network 1, countermeasures can be triggered in a targeted manner as a function of the loss reports arising. For example, those students who are no longer in the monitored group can be reported to a class teacher on a walking excursion. In an embodiment, it is also possible to indicate the time point from which the monitored nodes or students respectively have no longer been in the group and which node last reported the lost student or node as present. Here, the class teacher can then question that student who is wearing the network node that last confirmed the presence of the lost student.

In another embodiment of the inventive network or system respectively, the loss report for a node 2-i is not only reported to another node 2-j but to all nodes 2-i within the group. For example, the loss of a group member in the case of a skiing tour can be reported to all members of the skiing party.

The inventive mobile network node 2, as shown in FIG. 2, can, for example, be integrated in to an armband or a neck chain. Moreover, it is possible for the inventive network node 2, as shown in FIG. 2, to be integrated into a person's clothing. Furthermore, it is possible to integrate the network node 2 in to a portable mobile terminal, such as into an avalanche search device for skiers. Furthermore, the inventive network node 2, as shown in FIG. 2, is, in a possible embodiment, integrated in to packaging or into an object to be monitored.

The inventive network node 2 is particularly suitable for all situations in which several people are located in a hazardous environment and would like to mutually monitor their presence. These situations arise, for example, in the case of leisure activities or in a professional context. With regard to leisure activities, the inventive system is also suitable for dive groups comprising several divers. In the presently contemplated embodiment, several divers in a group each have a network node 2 and monitor their mutual presence in the group. Here, beacon data packets are not transmitted over an air interface but in water.

The physical transmission of the beacon data packets is not restricted to transmission by radio. In an embodiment, the beacon data packets B-DP are transmitted by modulated sound signal, such as in water. In a further embodiment, the beacon data packets B-DP are transmitted in the form of light signals.

The inventive network 1 enables the collective and continuous monitoring of the network nodes 2 by the network 1 even without the availability of an infrastructure provided for the purpose. The inventive network 1 is particularly robust with respect to signal interference on the transmission channels and with respect to the failure of individual network nodes.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-15. (canceled)

16. A mobile network node for a network, the mobile network node being configured to continuously monitor a presence of other mobile network nodes in a specific group of mobile network nodes, check whether the mobile network node is receiving, over an interface, beacon data packets sent from the other mobile network nodes, the beacon data packets being sent out at regular time intervals by the other mobile network nodes, wherein each of the beacon data packets received by the mobile network node includes an identifier of a transmitting network mode of the other mobile network nodes that transmitted the each of the beacon data packets and identifiers of those of the other mobile network nodes whose presence the transmitting network node is monitoring.

17. The mobile network node as claimed in claim 16, further comprising a memory in which a monitoring list of identifiers of all mobile network nodes to be monitored by the mobile network node is stored.

18. The mobile network node as claimed in claim 16, further comprising a microprocessor having at least one timer that checks whether the mobile network node has received, within a predetermined time period, one associated beacon data packet in each case from all of the other mobile network nodes to be monitored.

19. The mobile network node as claimed in claim 16, wherein the each of the beacon data packets received by the mobile network node includes a numerical value indicating how many mobile network nodes are monitoring a presence of the transmitting network node.

20. The mobile network node as claimed in claim 17, wherein a loss list is stored in the memory of the mobile network node of those identifiers of those mobile network nodes to be monitored from which the mobile network node does not receive an associated beacon data packet within a predetermined time period.

21. The mobile network node as claimed in claim 20, wherein the network node is configured to insert an identifier of a disappeared network node to be monitored into a search list of the memory, from which the mobile network node does not receive the associated beacon data packet within the predetermined time period, and is configured to broadcast over the interface, as a broadcast message, a search request to search for the disappeared network node.

22. The mobile network node as claimed in claim 21, wherein the search request has a decrementable adaptively settable hop value that indicates whether the another mobile network node that receives the search request broadcasts its decrementable adaptively settable hop value as a broadcast message.

23. The mobile network node as claimed in claim 21, wherein the one of the other mobile network nodes, which receives the search request to search for a disappeared network nodes and ascertains that the identifier of the disappeared network node is in its monitoring list and not in its loss list, generates a corresponding report.

24. The mobile network node as claimed in claim 16, further comprising:
a sensor of a respective transmitting network node;
wherein each beacon data packet received by the mobile network node includes sensor data of the sensor, operating state data of the respective transmitting network node, and an identifier of a mobile network that indicates to which network the mobile network node belongs.

25. The mobile network node as claimed in claim 16, wherein the beacon data packet received by the mobile network node is transmitted in encrypted form using a key that is available to all the mobile network nodes in the network.

26. The mobile network node as claimed in one of claims 20, wherein the stored loss list of the mobile network node can be read out by one of a central network node and an external terminal.

27. A mesh network comprising a plurality of mobile network nodes according to claim 16.

28. A method for continuously monitoring presence of mobile network nodes in a network, comprising:
sending out beacon data packets at regular time intervals by each of the mobile network nodes in the network; and
checking, by one mobile network node of the mobile network nodes of the network, whether the one mobile network node is receiving, in a predefined time period, the beacon data packets sent out at the regular time intervals by the other network nodes in the network;
wherein each of the beacon data packets received by the one mobile network node includes an identifier of a transmitting network node of the other network nodes that transmitted the each of the beacon data packets and identifiers of those mobile network nodes whose presence a transmitting network node is monitoring.
